(19) United States
(12) Patent Application Publication
(10) Pub. No.: US 2014/0067745 A1
(43) Pub. Date: Mar. 6, 2014

(54) TARGETED AGRICULTURAL RECOMMENDATION SYSTEM

(71) Applicant: PIONEER HI-BRED INTERNATIONAL, INC., Johnston, IA (US)

(72) Inventors: Donald Avey, Ankeny, IA (US); Phillip L. Bax, Johnston, IA (US); Wade Alexander Givens, Hendersonville, TN (US); Robert L. Heimbaugh, Adel, IA (US); Steven Brent Mitchell, Ankeny, IA (US); Jun Wei, Waukee, IA (US)

(73) Assignee: PIONEER HI-BRED INTERNATIONAL, INC., Johnston, IA (US)

(21) Appl. No.: 13/793,673

(22) Filed: Mar. 11, 2013

Related U.S. Application Data
(60) Provisional application No. 61/695,129, filed on Aug. 30, 2012.

(51) Int. Cl. G06N 5/02

(52) U.S. Cl. CPC G06N 5/02
USPC 706/46

(57) ABSTRACT

Methods, apparatuses and computer program products are provided for providing targeted recommendations of agricultural inputs based on a given localized usage context. Methods are provided that include receiving one or more indications of the localized usage context, determining one or more suggested agricultural inputs based on the usage context, and causing the one or more suggested agricultural inputs to be provided. In the context of a further method, a plurality of usage scenarios may be presented for selection, each of the usage scenarios being associated with one or more additional indications of the localized usage context. According to an additional method, probabilities of achieving target and minimum acceptable yields may be determined and presented along with the usage scenarios, thereby allowing a user to select one or more usage scenarios in order to receive the input recommendations based thereon.

### CROSS REFERENCE TO RELATED APPLICATIONS

This application claims the benefit of priority to U.S. Provisional Application No. 61/695,129, titled TARGETED AGRICULTURAL RECOMMENDATION SYSTEM, which was filed Aug. 30, 2012, and is hereby incorporated by reference in its entirety.

### FIELD OF APPLICATION

Embodiments of the present invention relate generally to systems, methods, and computer program products for generating agricultural recommendations, and more particularly to systems, methods, and computer program products which provide targeted agricultural input recommendations based on a given localized usage context.

### BACKGROUND

The appropriateness of particular agricultural inputs, including products and practices, may be highly sensitive to the particular context in which they will be used. Effectively determining an appropriate agricultural input for a given usage context may involve the consideration of many factors, and may even involve the use of complex calculations, algorithms, and/or data models. Growers may not appreciate the importance of many of these factors, and the sheer number of possible agricultural inputs and the complexity involved in determining those that are appropriate and how they are best managed in any given usage context may make the process of determining optimal agricultural inputs extremely difficult. Thus, without sophisticated recommendation tools capable of taking the relevant localized usage context into consideration, the complexity inherent in determining appropriate agricultural inputs and their use may cause suboptimal decisions about agricultural inputs to be made.

### SUMMARY

A method, apparatus and computer program product are therefore provided according to an example embodiment of the present invention for providing targeted recommendations of agricultural inputs based on a given localized usage context. In this regard, the method, apparatus, and computer program product of one embodiment may receive a plurality of usage context indicators and determine one or more suggested inputs based thereon.

In one embodiment, a method for generating agricultural input recommendations is provided that includes receiving one or more indications of a localized usage context, determining one or more suggested agricultural inputs based on the one or more indications, and causing the one or more suggested agricultural inputs to be provided.

In another embodiment, a method of producing a crop in a particular area is provided that includes providing one or more indications of a localized usage context associated with the particular area to an agricultural recommendation system. The agricultural recommendation system is configured to receive the one or more indications of the localized usage context, determine one or more suggested agricultural inputs based on the one or more indications, and cause the one or more suggested agricultural inputs to be provided. The method further includes producing the crop in the particular area in accordance with the one or more recommended agricultural inputs.

In a further embodiment, a method of managing an intra- or inter-field management zone is provided that includes providing one or more indications of a localized usage context associated with the intra- or inter-field management zone to an agricultural recommendation system. The agricultural recommendation system is configured to receive the one or more indications of the localized usage context, determine one or more suggested agricultural inputs based on the one or more indications, and cause the one or more suggested agricultural inputs to be provided. The method further includes managing the intra- or inter-field management zone in accordance with the one or more suggested agricultural inputs.

In another embodiment, a method of optimizing a crop production is provided that includes providing one or more indications of a localized usage context associated with the crop production to an agricultural recommendation system. The agricultural recommendation system is configured to receive the one or more indications of the localized usage context, determine one or more optimized suggested agricultural inputs based on the one or more indications, and cause the one or more optimized suggested agricultural inputs to be provided. The method further includes producing the crop in accordance with the one or more optimized suggested agricultural inputs.

In a further embodiment, a method of minimizing crop production risk is provided that includes providing one or more indications of a localized usage context associated with the crop production to an agricultural recommendation system, the indications of the localized usage context comprising information related to one or more risk levels. The agricultural recommendation system is configured to receive the one or more indications of the localized usage context, determine one or more optimized suggested agricultural inputs based on the one or more indications, and cause the one or more optimized suggested agricultural inputs to be provided. The method further includes producing the crop in accordance with the one or more suggested agricultural inputs.

In another embodiment, a method of minimizing crop production input costs is provided that includes providing one or more indications of a localized usage context associated with the crop production to an agricultural recommendation system, the indications of the localized usage context comprising information related to one or more input costs. The agricultural recommendation system is configured to receive the one or more indications of the localized usage context, determine one or more optimized suggested agricultural inputs based on the one or more indications, and cause the one or more optimized suggested agricultural inputs to be provided. The method further includes producing the crop in accordance with the one or more suggested agricultural inputs.

In a further embodiment, an apparatus is provided that includes at least one processor and at least one memory including program code instructions, the at least one memory and the program code instructions being configured to, with the processor, direct the apparatus to at least receive one or more indications of a localized usage context, determine one or more suggested agricultural inputs based on the one or more indications, and cause the one or more suggested agricultural inputs to be provided.

In an even further embodiment, a computer program product is provided that includes a non-transitory computer readable medium storing program code portions therein. The computer program code instructions are configured to, upon execution, direct an apparatus to at least receive one or more indications of a localized usage context, determine one or more suggested agricultural inputs based on the one or more indications, and cause the one or more suggested agricultural inputs to be provided.

In a still further embodiment, an apparatus is provided that includes means for receiving one or more indications of a localized usage context, means for determining one or more suggested agricultural inputs based on the one or more indications, and means for causing the one or more suggested agricultural inputs to be provided.

### BRIEF DESCRIPTION OF THE SEVERAL VIEWS OF THE DRAWINGS

Reference will now be made to the accompanying drawings, which are not necessarily drawn to scale.

FIG. 1 is a schematic representation of a targeted agricultural input recommendation (TAIR) system configured in accordance with an example embodiment;

FIG. 2 is a block diagram of an apparatus that may be embodied by or associated with an electronic device, and may be configured to implement example embodiments of the present invention;

FIG. 3 is a flowchart illustrating operations performed in accordance with an embodiment of the present invention;

FIGS. 4 through 6 are schematic representations of example user interfaces configured in accordance with embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present application is generally directed to systems, methods, and computer program products for generating recommendations regarding agricultural inputs, and more particularly to systems, methods, and computer program products that provide targeted agricultural input recommendations based on a given localized usage context. Embodiments of such targeted agricultural input recommendation (TAIR) systems, methods, and computer program products can be configured to receive one or more indications of a localized usage context and determine, e.g., generate, one or more agricultural input recommendations appropriate for that localized usage context. As used herein, a “localized usage context” refers to the context, e.g., conditions, in which the agricultural input for which a user is seeking suggestions will be used. The usage context is “localized” in the sense that it is related to a particular location, e.g., a particular area. For example, a particular farm; field; group of fields, such as an inter-field management zone; portion of a field, such as an intra-field management zone; or other geographical area, may be considered a localized usage context. Likewise combinations of one or more farms, fields, intra- or inter-field management zones, or other geographical areas may be considered a localized usage context. Information regarding, e.g., indicators of, the localized usage context may be received from a wide variety of sources, such as from user input, data models or datasets, sensors, and/or other sources.

As used herein, “agricultural inputs” or, as referred to in some cases, simply “inputs,” include any type of products, services, management practices, and/or the like which are involved in agriculture. While a number of specific examples of agricultural inputs will be provided throughout this disclosure, it will be understood that such examples are not intended to limit the scope of the invention and, accordingly, the definition of agricultural inputs should be interpreted as including any number of other products, management practices, and/or the like which are or may be used in agriculture, either now or in the future, even if not disclosed explicitly herein. It will be understood that agricultural inputs may be further inclusive of products, services, management practices, and/or the like which may seem ancillary to the physical cultivation of animals, plants, or the like, but which nonetheless are involved in agriculture. Non-limiting examples of such inputs may include, for example, risk management products or practices, such as insurance products or hedging practices.

For the purposes of clarity and brevity of discussion, operations and features will now be described as being carried out simply by the “TAIR system.” However, it will be understood that, as will be described in further detail below, each of these operations may in actuality be performed, for example, by one or more apparatuses which may, for example, be embodied by or otherwise associated with one or more devices and/or network entities, such as one or more user devices and/or servers, and comprising means such as one or more processors, memory devices, communication interfaces, sensor and/or control interfaces or the like.

As discussed above, the TAIR system may generate recommendations based on a localized usage context. In other words, the TAIR system may generate recommendations based on the specific context, e.g., conditions, of a particular area in which the one or more recommended inputs may be used. A wide variety of information, e.g., indications, may be provided to define the localized usage context. For example, the TAIR system may be provided with indications of the localized usage context such as one or more of: a geographic location, such as a longitude and latitude, a map, an image, a polygon or arbitrary shape drawn on a map, a territory, an address, etc.; a date, time or stage, such as but not limited to date, time of day, phenological stage, a period of time, an event, a date or time associated with an event such as a farm, field or crop management action, a weather event such as wind, rain, hail, temperature, a date or time associated with an event that triggers an alert or warning, a date or time associated with action taken in response to an event, predicted stage, an alert or warning; weather or other environmental information, e.g., a macro weather pattern or climate forecast (e.g., El Nino or La Nina) expected to occur, expected weather conditions for an upcoming year, historical weather information, etc.; one or more soil characteristics, e.g., soil type, drainage characteristics, soil pH, topography, moisture holding capacity, soil moisture, water holding capacity, depth, slope, productivity, depth to a restrictive layer, depth to a water table, flooding frequency, soil texture, etc.; one or more field or field management zone characteristics, e.g., dominant soil type or soil class, dominant soil texture, average yield level or productivity index, cropping history, tillage history, chemical application history, presence and/or adequacy of tile or other drainage, etc.; and/or a previous crop e.g., the last crop that a grower planted in a particular location.

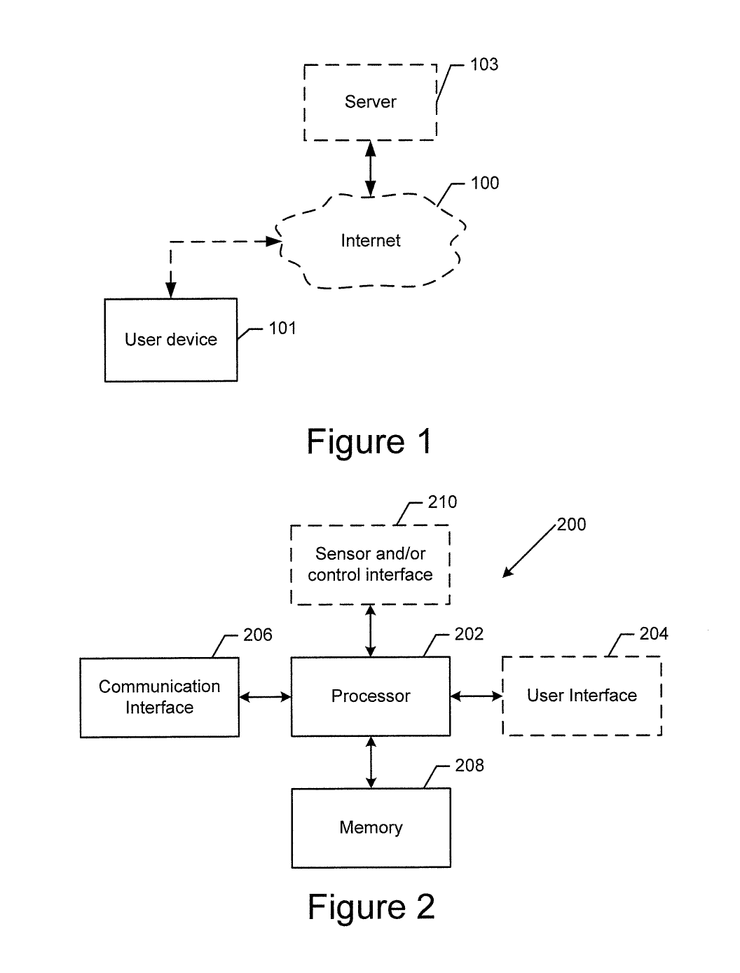

The indications of the localized usage context may also include information related to various targets and/or goals. For example, the indications of the localized usage context may include one or more indications of a target yield, e.g., a yield as measured in bushels/acre or another unit that a grower wants to achieve, and a minimum yield, e.g., a yield as measured in bushels/acre or another unit that a grower does not want to fall below. They may also include other information related to targets and/or goals, such as an environmental stewardship target or goal, a farm, field, or crop management timing goal such as a time to plant a particular crop, or at a particular location, a time to harvest a particular crop or harvest a particular location, monitoring a target window for a particular phenological stage (e.g., a vegetative stage, a reproductive stage, a maturation stage, and the like), or use of plant or harvest material (e.g., specialty grain, grain, cellulosic biomass, forage stock, and the like), a target income, breakeven points on costs, quality level, moisture content, post cropping residue level, risk level (e.g., maximum risk level or target risk level), or other parameters or measurements for which a grower may have established certain goals or targets. The targets and/or goals may also include, for example, one or more crop characteristics, such as lodging, brittle snap, stress emergence (e.g., cold, dry, wet), seed shatter, stress tolerance (e.g., biotic or abiotic stress), drought tolerance, cold tolerance, pest tolerance, herbicide tolerance, nitrogen utilization, silage characteristics, dry down properties, yield, harvest properties, and/or end-product trait characteristics (e.g., high extractable starch, specialty oil content (e.g., high oleic acid, low linolenic acid), and/or ethanol yield/bushel). After receiving the provided indications, the TAIR system may determine and/or provide, e.g., cause to be displayed, one or more suggested agricultural inputs and/or levels or degrees of inputs, such as agricultural products or agricultural practices, as will be detailed below. It will be understood that some of the information and/or indications may be provided by a user, while other information (for example, the weather forecast) may instead be provided from one or more other sources, such as from a data model stored in a server, such as the server 103 depicted in FIG. 1.

In this regard, the TAIR system may determine recommendations based on a wide array of datasets and/or data models that may also act as indicators of the localized usage context. The TAIR system may, for example, access any of these data models via the internet or another network, such as by connecting with a server hosting the data, such as the server 103 depicted in FIG. 1. According to some embodiments, one or more of the data models and/or data sets may also or alternatively be stored locally, such as in a memory of the user device 101 depicted in FIG. 1. According to certain example embodiments, the TAIR system may, for example, reference or query these datasets and/or data models, for example, using indicators of the localized usage context provided through other means. For example, the TAIR system may query one or more datasets and/or data models with a location received from a user.

These datasets and/or data models may include, for example, crop models; soil datasets; product datasets; location-specific historical data; crop management datasets; insect, weed, and/or disease datasets; historical, current, and/or forecast crop price datasets; crop nutrient data sets; pest management datasets; seed treatment datasets; pesticide and/or herbicide datasets; customer information data sets; yield monitor data sets; product performance data sets or the like. Other datasets and/or data models containing indications of the localized usage context such as information about a wide range of environmental factors may also or alternatively be used, such as weather models, historical weather datasets, current weather data sets and/or models, weather forecasts (e.g., sort-term or long-term forecasts), environmental contamination datasets and/or models (e.g., ozone levels, airborne particulate levels, soil contaminants, water quality, etc.), solar radiation datasets and/or models. The weather datasets and/or data models may, for example, include indications of the localized usage context such as information regarding temperature amplitudes, wind speeds, storm velocities, relative humidity, rainfall rates or intensities, drought severities, drought frequencies, and/or the like. Other data models covering a wide range of biotic and abiotic factors indicating the localized usage context may also or alternatively be used. For example, data models for various pests and/or pathology, such as historical or predicted insect and/or disease (fungal, bacterial, viral, and abiotic) infestation levels and treatment thresholds, weed growth models, nematode models, etc. may be used. As another example, indications of the localized usage context data models such as crop physiology models, nutrient cycling and nutrient use models, irrigation models, hydrology models, those incorporating geography, topography, elevation data, satellite or aerial imagery, weather forecasting models. In addition, the use of models that relate one or more localized data sets to wider area data sets such as at a county wide, state wide, nationwide or international scale data sets may be used. The TAIR system may also or alternatively receive indications of the localized usage context from financial datasets and/or data models such as, for example, crop price forecasts, pricing models, financial models, stochastic models and/or Monte Carlo simulations.

In addition to the above data models and/or datasets, the TAIR system may also access datasets and/or data models which contain historical localized usage contexts associated with one or more respective identifiers (e.g., user accounts, user profiles, customer identifications, farms, geographic areas, or any other identifier). In this way, a user of the TAIR system may, for example, provide an identifier, such as by logging in or entering a geographic location, and the TAIR system may automatically receive any or all indications of the localized usage context associated with the identifier from the historical localized usage context database. Any or all of the above data models and/or datasets may, for example, be publicly available or may be privately controlled. According to other example embodiments, any of the indications of the localized usage context contained in the above data models and/or data sets may alternatively or additionally be received directly, such as via user input. In other example embodiments, the datasets and/or data models may be generated from sensors, such as weather stations, which may even in some cases be located in the particular area defining the localized usage context. In other embodiments, as will now be discussed, data may be received directly from sensors, instead of from an intermediate dataset.

In this regard, and in addition to leveraging data models and/or data sets as discussed above, the TAIR system may also or alternatively receive indications of the localized usage context from one or more sensors. For example, the TAIR system may receive indications of the localized usage context from weather sensors such as rainfall sensors (e.g. sensors configured to detect rainfall rates and/or total accumulated rainfall over a period of time), temperature sensors, wind sensors (e.g., sensors configured to detect wind speed and/or direction), relative humidity sensors, dew point sensors, solar radiation sensors, barometers, Doppler radars or the like. The TAIR system may also, for example, receive one or more indications of the localized usage context, such as a geographic location, from a GPS or other positioning device or system, such as a GPS device located on the user device 101, or an agricultural machine such as a planter, combine, sprayer, or the like. The TAIR system may also or alternatively receive indications of the localized usage context received from sensors configured to detect various soil characteristics, such as sensors configured to detect soil temperature, available water content, organic matter content, nitrogen content, phosphorous content, pH, micronutrient content, nutrient cycling, nutrient variability, nutrient availability (e.g. nitrogen, potassium, phosphorus, micronutrients, etc.), nutrient availability maps, moisture content, irrigation water applied to a defined area or location, bulk density, electrical conductivity, etc. Data from various planting sensors, e.g., sensors configured to detect various characteristics of the planting process, may also or alternatively be used by the TAIR system. For example, the TAIR system may receive indications of the localized usage context from sensors configured to detect seed drop, seed population, seed flow, fertilizer application information and/or chemical application information. In addition, indications of the localized usage context may also or alternatively be received from sensors configured to detect characteristics of a planting machine or system such as vacuum, air pressure, and/or ground speed sensors. Indeed, any type of sensor may be used with the TAIR system so as to provide indications of a localized usage context. Further examples include: canopy temperature sensors, optical sensors, light interception sensors, infrared sensors (e.g., heat/temperature sensors), near infrared sensors, red edge sensors, visible light sensors, hyperspectral light sensors, planter downforce sensors, tillage equipment draft sensors (e.g., sensors configured to measure the force required to pull an implement through the soil), ground penetrating radar, LIDAR (light detection and ranging) sensors, sound sensors (e.g., microphones), electrochemical gas sensors, sensors configured to sample water for fungal and/or bacterial spores or environmental contaminants, leaf sensors, flow sensors, photoelectric sensors, tilt sensors, and/or colorimeters.

Any of the sensors from which data is received may further be configured to employ geotagging functionality, so as to associate a respective measurement with a location. The geotagging functionality may also, for example, associate the respective measurement with a specific date and/or time, such as via a time and/or date stamp associated with the measurement data. According to an example embodiment, the TAIR system may automatically receive indications of the localized usage context from sensors which are configured to employ geotagging functionality upon receiving a geographic location. Similarly, the TAIR system may also automatically receive indications of the localized usage context from data models and/or datasets in which data, e.g., indications of the localized usage context, are associated with a geographic location upon receiving a geographic location. In this way, the TAIR system may receive a geographic location as an indication of a localized usage context and, in response, may automatically determine one or more additional indications of the localized usage context by querying one or more sensors, datasets, and/or data models using the received geographic location.

As mentioned previously, any of the indications of the localized usage context from the above described sensors may, according to certain example embodiments, be received via an intermediate dataset and/or data model. That is, any of the indications of the localized usage context described as being received from a sensor may alternatively or additionally be received from an associated dataset or data model. Furthermore, any of the data from the above described sensors may, according to certain example embodiments, be received directly, such as via user input. By taking localized usage contexts into account, and by potentially leveraging one or more data models, data sets, and/or sensor data, the TAIR system may quickly provide accurate recommendations, avoiding suboptimal product and/or other agricultural input recommendations and purchasing or management decisions, and thereby providing one or more of increasing the agricultural production of grower customers, increasing profitability, increasing efficiency, reducing or mitigating risk, or improving short-term or long-term resource allocation or usage. It will also be understood that a localized usage context may change, for example, over the course of a year, a planting season, or over even shorter periods of time, such as over the course of weeks, days, or even hours. Thus, the TAIR system may additionally or alternatively be used to generate agricultural input recommendations not just in preparation for a planting season, but also throughout the season and, indeed, perhaps to determine or even automatically make (such as in instances in which the TAIR system is embodied by or otherwise associated with equipment configured to adjust agricultural inputs) adjustments to agricultural inputs in real time.

According to another example embodiment, the TAIR system may iteratively improve its recommendations, such as by utilizing one or more machine learning algorithms. For example, according to one example embodiment, the TAIR system may, at a first point in time, receive information regarding a localized usage context, such as that described above, and determine a first set of one or more agricultural input recommendations. At a second point in time, the TAIR system may receive, e.g., in addition to the information discussed above, information regarding the results of utilizing the first set of agricultural input recommendations and, based at least in part on this information, determine a second set of one or more agricultural input recommendations. This process may then be repeated over periods of time such as hours, days, or weeks, over any number of harvests, or over growing cycles. In this way, the TAIR system may continually improve and update its recommendations, such as by comparing expected vs. actual results.

According to another example, one or more usage scenarios, e.g., planting scenarios, may be presented after receiving the indications of the localized usage context, each scenario having one or more indications of the localized usage context associated with it. A user may then be permitted to select one or more of the displayed planting scenarios and, in response, be presented with one or more suggested agricultural inputs. According to another embodiment, associated recommendations may be determined for each usage scenario and displayed, without requiring a user to select any of the scenarios. Indications of the localized usage context which may be associated with one or more usage scenarios may include, for example, one or more planting windows (e.g., a time of year when planting will occur), crop types and/or varieties or combinations of varieties, population (e.g., planting density or planting rate, whether variable or fixed), row width, field or field management zone preparations (e.g., till, no-till, etc.), and/or chemical treatments (e.g., herbicides, pesticides, fertilizers, seed treatments, etc. that may be used). Any of these indications may, according to some embodiments, be directly received similarly to the previously discussed indications, and those previously discussed indications may be received indirectly as well. In other words, any of the information related to, e.g., indications of, the localized usage context may be received directly, such as via user input, or from an external location such as a data model stored on a server, or by being associated with a planting scenario. In this way, the planting scenarios may allow easy and efficient comparisons to be made between the recommendations generated by the TAIR system based on various localized usage contexts. As a specific example, a user may input those indications of the localized usage context which are, for example, outside of their control or more difficult to control, such as a weather forecast and one or more soil characteristics, and then select one or more planting scenario associated with indications of the localized usage context which are under the user's control, such as a planting window and planting density. Thus, a user will be able to see, at a glance, the effect that making adjustments such as moving a planting window forward or backwards and/or increasing the planting density would have on the agricultural input recommendations generated by the TAIR system.

The TAIR system may determine a wide variety of recommended agricultural inputs based on the indications of a localized usage context discussed above. For example, agricultural inputs may include various agricultural products, such as seed products (e.g., corn, soybeans, canola, sorghum, sunflower, wheat, millet, cotton, rice, alfalfa, sugar beets, fruits, nuts, etc.), fertilizer products (such as, for example, nitrate or nitrate-based products, phosphates, potash, and/or sulfur), fungicides, pesticides, or any number of other agricultural products. In an instance in which agricultural products are being recommended and a geographic location has been received, the agricultural product recommendations may be based at least in part on product availability in the geographic location. Agricultural inputs may also or alternatively include, for example, management practices, such as tilling practices, watering practices, planting practices, silage practices, field or field management zone preparation instructions, management zone divisions (e.g., how to best divide one or more fields into one or more intra- or inter-field management zones), irrigation recommendations, tile drainage practices, field or field management zone scouting guidelines, timing recommendations for any of these and/or any number of other management practices. The suggested management zone divisions may, for example, be determined and provided via a graphical geographic representation.

According to an example embodiment, financial and/or risk management recommendations may also be determined, such as recommendations regarding the use of crop insurance instruments or marketing services, recommendations regarding when and how to sell crops, recommendations regarding risk management, such as the use of futures markets, forward contracts, or other hedging methods. According to another example embodiment, a single optimized set of, e.g., one or more, recommended agricultural inputs may be determined. The optimized set of recommended agricultural inputs may, for example, be determined and provided at the option of a user. According to other embodiments, a plurality of optimized sets of recommended agricultural inputs may be determined, for example, in a list ranked by how optimal each respective optimized set of recommendations is based on the received indications of the localized usage context. According to still further embodiments, the number of recommended agricultural inputs or sets of recommended agricultural inputs may be configurable, such as by a user. It should be understood that any of the indications of a localized usage context discussed above may also or alternatively be considered a recommended agricultural input determined by the TAIR system. For example, the TAIR system may determine one or more recommended planting windows. In this way, the pool of possible indications of a localized usage context and possible recommended agricultural inputs determined by the TAIR system should be considered coextensive, or nearly so. That is, as used herein, the difference between an agricultural input and an indication of a localized usage context is whether the TAIR system is receiving it or determining it as a recommendation.

According to some embodiments, one collection of input recommendations may be determined and presented for one localized usage context, e.g., for one set of indications of the localized usage context. According to another example embodiment, however, the TAIR system may also or alternatively provide a portfolio of management recommendations, such as one or more recommendation for each of a plurality of localized usage contexts, e.g., for each of a plurality of fields or areas within one or more fields (e.g., for each of a plurality of field management zones). These recommendations for each field or portion of a field may include one or more of any of the agricultural inputs discussed above and may vary between each field or portion of a field.

Having thus described generally the various features and operations of the TAIR system, embodiments of the present invention will be described more fully hereinafter with reference to the accompanying drawings. It should be understood that these drawings show some, but not all, embodiments of the invention. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, processed and/or stored in accordance with embodiments of the present invention. Thus, use of any such terms should not be taken to limit the spirit and scope of embodiments of the present invention.

Additionally, as the term will be used herein, “circuitry” may refer to hardware-only circuit implementations (e.g., implementations in analog circuitry and/or digital circuitry); combinations of circuits and computer program product(s) including software and/or firmware instructions stored on one or more computer readable memories that work together to cause an apparatus to perform one or more functions described herein; and circuits, such as, for example, one or more microprocessors or portions of a microprocessors, that require software or firmware for operation even if the software or firmware is not physically present. This definition of “circuitry” is applicable to all uses of this term, including in any claims. As another example, the term “circuitry” also includes implementations comprising one or more processors and/or portion(s) thereof and accompanying software and/or firmware. As another example, the term “circuitry” also includes, for example, an integrated circuit or applications processor integrated circuit for a portable communication device or a similar integrated circuit in a server, a network device, and/or other computing device.

As defined herein, a “computer-readable storage medium” refers to a non-transitory physical storage medium (e.g., volatile or non-volatile memory device), and can be differentiated from a “computer-readable transmission medium,” which refers to an electromagnetic signal.

FIG. 1 illustrates a block diagram of a TAIR system. While FIG. 1 illustrates one example of a configuration of a TAIR system, numerous other configurations may be used to implement embodiments of the present invention. With reference to FIG. 1, however, the TAIR system includes a user device 101, and may include a network entity, such as a server 103. The user device 101 may, according to some embodiments, be a device that is configured to communicate over one or more common networks, e.g., a network to which both devices are connected, such as the internet 100. For example, the user device 101 may be a mobile terminal, such as a mobile telephone, PDA, laptop computer, tablet computer, or any of numerous other hand held or portable communication devices, computation devices, content generation devices, content consumption devices, or combinations thereof. The user device 101 may also be any of a number of devices that utilize the recommendations to control various devices and equipment in applying inputs, such as devices configured to change an application rate of an input, or to change the input itself (e.g., configured to change a crop variety, fertilizer source, herbicide, pesticide, etc.) in response to the changes in the indications of the localized usage context, including changes to indications of the localized usage context received from datasets, data models, and/or sensors, whether the changes occur over time or space (e.g., within a field, such as from intra-field management zone to intra-field management zone, or from field to field, such as from inter-field management zone to inter-field management zone). The server 103 may be any type of network-accessible device that includes storage and may be configured to communicate with the user device 101 over one or more common networks, such as the internet 100. The server 103 may store data, such as geographic data, weather data, weather models, product information, account information, and/or customer information, along with any other type of content, data or the like which may, for example, be provided to the user device 101 during use of the TAIR system. For example, the server 103 may store data associated with one or more of the previously-listed datasets and/or data models. The server 103 may also communicate with other servers or devices, such as other user devices, as well as other servers or data terminals including servers and systems providing data similar to that described above, over one or more networks, such as the internet 100. The user device 101 and/or server 103 may include or be associated with an apparatus 200, such as shown in FIG. 2, configured in accordance with embodiments of the present invention, as described below.

As shown in FIG. 1 and mentioned above, the user device 101 and server 103 may communicate with one another, such as via a common network, such as the internet 100. The user device 101 and server 103 may connect to the common network, e.g., the internet 100, via wired or wireless means, such as via one or more intermediate networks. For example, the user device 101 and/or server 103 may connect with the common network, e.g., the internet 100, via wired means such as Ethernet, USB (Universal Serial Bus), or the like, or via wireless means such as, for example, WI-FI, BLUETOOTH, or the like, or by connecting with a wireless cellular network, such as a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network or other type of network. The user device 101 and server 103 may also communicate with one another directly, such as via suitable wired or wireless communication means.

Example embodiments of the invention will now be described with reference to FIG. 2, in which certain elements of an apparatus 200 for carrying out various functions of the TAIR system are depicted. As noted above, in order to implement the various functions of the TAIR system, the apparatus 200 of FIG. 2 may be employed, for example, in conjunction with either or both of the user device 101 and the server 103 of FIG. 1. However, it should be noted that the apparatus 200 of FIG. 2 may also be employed in connection with a variety of other devices, both mobile and fixed, in order to implement the various functions of the TAIR system and therefore, embodiments of the present invention should not be limited to those depicted. It should also be noted that while FIG. 2 illustrates one example of a configuration of an apparatus 200 for implementing the functions of the TAIR system, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, the apparatus 200 for implementing the various functions of the TAIR system may include or otherwise be in communication with a processor 202, a communication interface 206, a sensor and/or control interface 210, and a memory device 208. As described below and as indicated by the dashed lines in FIG. 2, the apparatus 200 may also include a user interface 204, such as when the apparatus 200 is embodied by or otherwise associated with the user device 101. In some embodiments, the processor 202 (and/or co-processors or other processing circuitry assisting or otherwise associated with the processor 202) may be in communication with the memory device 208 via a bus configured to pass information among components of the apparatus 200. The memory device 208 may, for example, include one or more volatile and/or non-volatile memories. The memory device 208 may be configured to store information, data, content, applications, instructions, or the like, for enabling the apparatus 200 to carry out various functions in accordance with an example embodiment of the present invention. For example, the memory device 208 may be configured to store instructions, such as program code instructions, that, when execution by the processor 202, cause the apparatus 200 to carry out various operations. The sensor and/or control interface 210 may include circuitry configured to interface with one or more sensors, such as any of the sensors discussed above, and/or to control one or more external devices and/or equipment, such as devices or equipment configured to apply or change inputs, as discussed above. Thus, according to some embodiments, the sensor and/or control interface 210 may include one or more ports, such as one or more USB, PCI ports or the like configured to establish a connection with the one or more external sensors, devices, and/or equipment. According to other embodiments, the external sensors, devices, and/or equipment may be accessible, for example, via a network, such as the internet 100. Thus, a wired or wireless connection between apparatus 200 and external sensors, devices, and/or equipment may be established via the communication interface 206 and the sensor and/or control interface 210 may be configured to, for example, access, read, translate, manage, format, or otherwise handle data received from or sent to the external sensors, devices, and/or equipment. In such an embodiment, sensor and/or control interface 210 may, alternatively or additionally, be embodied as software, such as program code instructions embodied in memory 208 and executable by processor 202.

The processor 202 may be embodied in a number of different ways. For example, the processor 202 may be embodied as one or more of a variety of hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more processors configured in tandem via the bus to enable independent execution of instructions, pipelining and/or multithreading.

In an example embodiment, the processor 202 may be configured to execute instructions stored in the memory device 208 or otherwise accessible to the processor 202. Alternatively or additionally, the processor 202 may be configured to execute hard coded functionality. As such, whether configured by hardware or software methods, or by a combination thereof, the processor 202 may represent an entity (e.g., physically embodied in circuitry) capable of performing operations according to an embodiment of the present invention while configured accordingly. Thus, for example, when the processor 202 is embodied as an ASIC, FPGA or the like, the processor 202 may be specifically configured hardware for conducting the operations described herein. Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor of a specific device (e.g., the user device 101 or the server 103) configured to employ an embodiment of the present invention by further configuration of the processor 202 by instructions for performing the algorithms and/or operations described herein. The processor 202 may include, among other things, a clock, an arithmetic logic unit (ALU) and logic gates configured to support operation of the processor 202.

Meanwhile, the communication interface 206 may be any means such as a device or circuitry embodied in either hardware or a combination of hardware and software that is configured to receive and/or transmit data from/to a network, such as the internet 100, and/or any other device or module in communication with the apparatus 200. In this regard, the communication interface 206 may include, for example, an antenna (or multiple antennas) and supporting hardware and/or software for enabling communications with a wireless communication network. Additionally or alternatively, the communication interface 206 may include the circuitry for interacting with the antenna(s) to cause transmission of signals via the antenna(s) or to handle receipt of signals received via the antenna(s). In some environments, the communication interface 206 may alternatively or also support wired communication. As such, for example, the communication interface 206 may include a communication modem and/or other hardware/software for supporting communication via cable, digital subscriber line (DSL), universal serial bus (USB) or other mechanisms.

In some embodiments, such as instances in which the apparatus 200 is embodied by the user device 101, the apparatus 200 may include a user interface 204 in communication with the processor 202 to receive indications of user input and to cause audible, visual, mechanical or other output to be provided to the user. As such, the user interface 204 may, for example, include a keyboard, a mouse, a joystick, a display, a touch screen(s), touch areas, soft keys, a microphone, a speaker, or other input/output mechanisms. The processor 202 may be configured to control one or more functions of one or more user interface elements through computer program instructions (e.g., software and/or firmware) stored on a memory accessible to the processor 202 (e.g., memory device 208). In other embodiments, however, such as in instances in which the apparatus 200 is embodied by server 103, the apparatus 200 may not include a user interface 204. In still other embodiments, multiple apparatuses 200 may be associated with respective devices or the components of the apparatus 200 may be distributed over multiple devices. For example, a first apparatus 200 may be embodied by or otherwise associated with the server 103 and may not include a user interface 204, while a second apparatus 200 may be embodied by or otherwise associated with the user device 101 and may include a user interface 204. In this way, the two apparatuses 200 may effectively function as a single distributed apparatus 200, with input and output operations, e.g., receiving input and displaying output, taking place at the user device 101, while processing operations, e.g., determining product recommendations, taking place at the server 103. It should be understood, however, that in this case, the second apparatus associated with the user device 101 may still include a processor 202 and memory 208 and both apparatuses may still include communication interfaces 206.

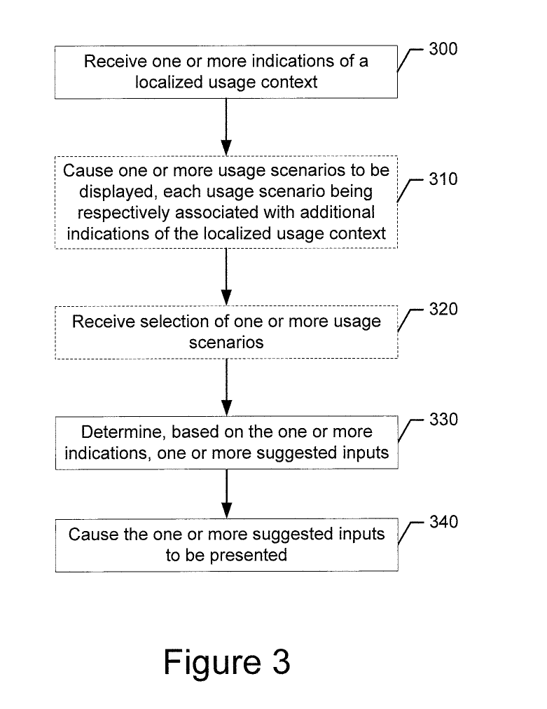

Referring now to FIG. 3, various operations of the TAIR system are depicted. As described below, the operations of FIG. 3 may be performed by one or more of apparatus 200, such as shown in FIG. 2, embodied by or otherwise associated with the user device 101 and/or the server 103. In this regard, apparatus 200 embodied by or otherwise associated with the user device 101 and/or server 103 may include means, such as the processor 202, the memory 208, the user interface 204, the communication interface 206, the sensor and/or control interface 210 and/or the like, for receiving one or more indications of a localized usage context, such as any of the indications of the localized usage context discussed above. See operation 300 of FIG. 3. The indications of the localized usage context may, according to an example embodiment, be received from a user, such as via the user interface 204 of apparatus 200 embodied by or otherwise associated with the user device 101. As discussed above, the indications of the localized usage context may additionally or alternatively be received, for example, from one or more datasets and/or data models stored locally, such as in the memory 208 of apparatus 200, or externally, such as in the server 103 of FIG. 1. Also as discussed above, the indications of the localized usage context may additional or alternatively be received, for example, from one or more sensors, such as those discussed above, such as via the sensor and/or control interface 210.

According to an example embodiment, one or more of the received indications of the localized usage context may be used to adjust, refine, or otherwise modify one or more other indications of the localized usage context. For example, the one or more soil characteristics, e.g., a moisture condition, may be modified based on the previous crop. As a specific example, if the previous crop is indicated as being cotton, sorghum, or another crop which may tend to reduce the moisture condition of soil, the indication of the soil moisture condition may be appropriately adjusted, e.g., lowered, to account for the effects of the previous crop. Likewise, the level of available soil nutrients (e.g. nitrogen, potassium, phosphorus, micronutrients, etc.) or maps of nutrient availability may be appropriately adjusted based on one or more previous crops. According to an example embodiment, historical tillage practices; weed, disease and/or pest infestation information; herbicide and/or other pesticide application information; tile drainage; and many other management practices or biotic and abiotic factors may also or alternatively be used to appropriately adjust one or more indications of the localized context. According to a further embodiment, one or more of the indications of the localized usage context may be modified and/or restricted based on an indication of the geographic location. For example, the TAIR system may take into account applicable regulations (e.g., any regulations applicable to the geographic location, such as regional, state, and/or national regulations), such as restrictions or regulations related to chemical use, refuge rules, or the like. Thus, for example, if a chemical or particular crop or management practice were, e.g., banned or restricted in a particular area, the TAIR system may account for this by limiting or adjusting associated indications of the localized usage context. According to a further embodiment, the TAIR system may also or alternatively determine agricultural recommendations based at least in part on such applicable regulations. The recommendations may also or alternatively be determined based at least in part on one or more goals related to stewardship of at least one of a product, a crop, a trait including a native trait or a transgenic trait, a location, or an environment.

Apparatus 200 embodied by or otherwise associated with the user device 101 and/or server 103 may further include means, such as the processor 202, the memory 208, the user interface 204, the communication interface 206 and/or the like, for determining a probability of achieving the target yield and for determining a probability of not achieving the minimum yield. See operation 310 of FIG. 3. These probabilities may be determined based on the indications of the localized usage context discussed above.

Apparatus 200 embodied by or otherwise associated with the user device 101 and/or server 103 may further include means, such as the processor 202, the memory 208, the user interface 204, the communication interface 206 and/or the like, for causing one or more usage scenarios to be displayed, each usage scenario being respectively associated with one or more additional indications of the localized usage context, such as any of those discussed above. See operation 320 of FIG. 3. As a specific example, the one or more scenarios may be associated with at least one of a population, e.g., a planting density or planting rate; a comparative relative maturity, e.g., a time for a crop or plant to reach maturity; a time for a crop to reach a defined growth stage; and/or planting window, e.g., a time of year or specific date which the grower intends to plant seed. The one or more additional indications of the localized usage context may further include one or more fertility indications or indications of one or more management practices, such as tilling; herbicide, fungicide, nematicide, or other pesticide application method, rate or timing; or the like. Furthermore, the probabilities of achieving the target yield and not achieving the minimum yield discussed above may, according to an example embodiment, be determined for each usage scenario. Thus, respective probabilities may be determined for each usage scenario based on the indications the localized usage context discussed previously, as well as the additional indications of the localized usage context respectively associated with each usage scenario. These probabilities may, according to an example embodiment, be displayed along with the usage scenarios. In this way, a user may be able to see the respective probabilities of achieving the target yield and not achieving the minimum yield for each usage scenario, which may aid the user in selecting the one or more usage scenarios as discussed below.

In this regard, the apparatus 200 embodied by or otherwise associated with the user device 101 and/or server 103 may further include means, such as those mentioned above, for receiving selection of one or more of the displayed usage scenarios. See operation 330. In this way, the additional indications of the localized usage context which are associated with the selected usage scenarios may be received and used in determining one or more suggested agricultural inputs, as discussed below. According to another example embodiment, however, the additional indications of the localized usage context may be received directly, such as via user input, instead of being received via selection of an associated usage scenario.

In this regard, apparatus 200 embodied by or otherwise associated with the user device 101 and/or server 103 may further include means, such as the processor 202, the memory 208, the user interface 204, the communication interface 206 and/or the like, for determining one or more suggested agricultural inputs based on the one or more indications of the localized usage context. See operation 340. Suggested inputs may be determined, for example, by cross-referencing the received indications of the localized usage context with one or more input information databases, such as may be stored, for example, in the memory 208 of an apparatus 200 embodied by or otherwise associated with the server 103 or another network entity.

Thus, according to an example embodiment, the input recommendation process carried out by the TAIR system may proceed in two stages. First, one or more initial indications of a localized usage context may be received. These initial indications of the localized usage context may include information such as a geographic location, environmental information, soil characteristics, a previous crop, a target yield and a minimum acceptable yield. Having received the initial indications, the TAIR system may cause a plurality of usage scenarios to be displayed, each usage scenario being associated with one or more additional indications of the localized usage context, along with probabilities of achieving the target yield and not achieving the minimum acceptable yield for each usage scenario. A user may then select one or more of the usage scenarios and be provided with one or more product suggestions for each selected usage scenario, the product suggestions being based on the initial and additional indications of the usage context.

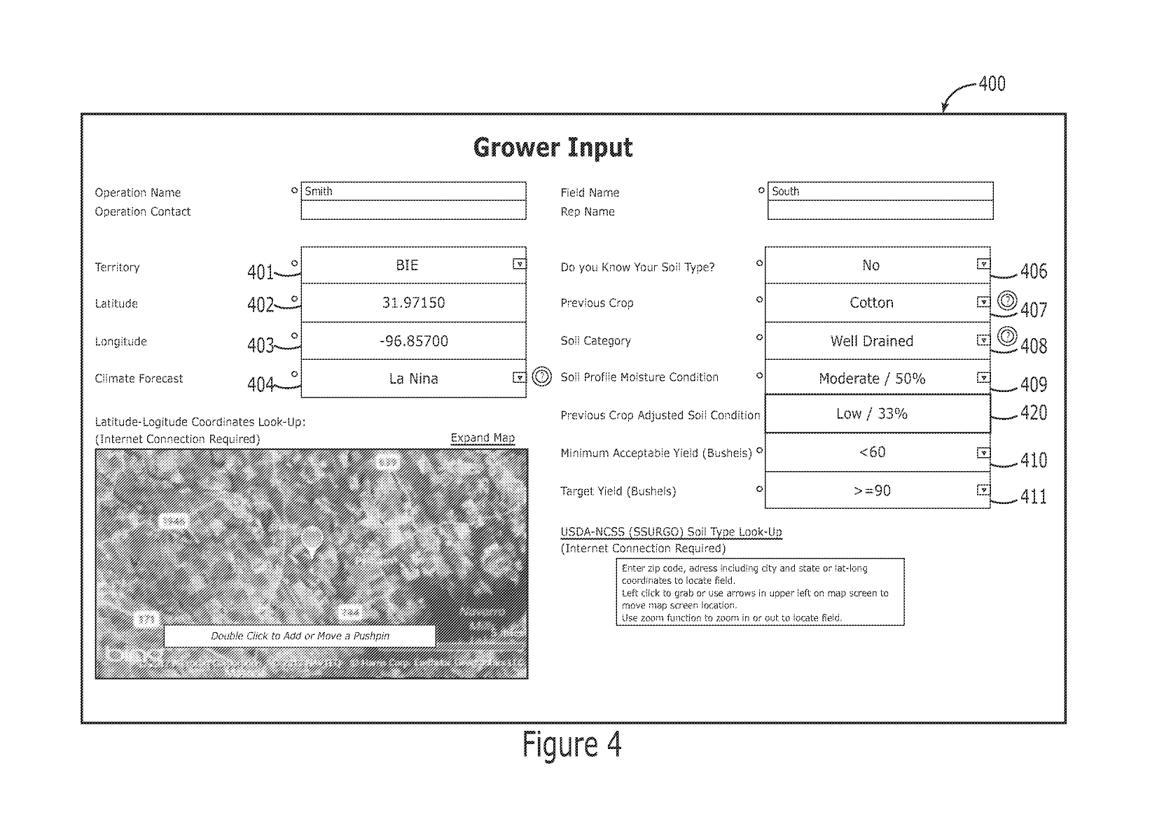

As mentioned at various points above, the operations of the TAIR system may involve presenting and receiving information, such as via user interface 204 of apparatus 200 embodied by or otherwise associated with a user device 101 and/or a server 103. Thus, having discussed examples of operations and features of the TAIR system generally, reference will now be made to FIGS. 4-6 in order to discuss specific examples of user interfaces which may allow users to interact with the TAIR system in order to receive targeted agricultural product recommendations.

FIG. 4 represents an example of a “grower input” viewable area 400, e.g., a view that may be initially provided to a user, e.g., a grower, to receive initial indications of a localized usage context. Accordingly, the “grower input” viewable area 400 may include form fields corresponding to various indications of the localized usage context. For example, the “grower input” viewable area 400 may include fields for receiving a territory 401, a latitude 402, a longitude 403, a climate forecast 404, a previous crop 407, a soil category 408, a soil profile moisture condition 409, a minimum acceptable yield 410, and/or a target yield 411. The fields may receive textual input or, in some cases, may receive input via a drop-down selection menu. The latitude and longitude fields 402 and 403 may, according to an example embodiment, be entered via a graphical geographic representation, e.g., a map 405. Thus, a user may, for example, select a location on the map 405 and, in response, the latitude and longitude fields 402 and 403 may be automatically populated based on the selected location.

Certain ones of the fields presented in the “grower input” viewable area 400 may be modified, and which fields are presented may change, based on the input received via one or more of the fields. For example, depending on what is selected in the “do you know your soil type?” field 406, e.g., whether “yes” or “no” are selected, the other fields related to soil conditions, e.g., the soil category field 408 and soil profile moisture condition field 409, may change. More specifically, if a user selects “yes” in the “do you know your soil type?” field, a different field, such as a “soil type” field (not depicted) may be presented to allow the user to enter their specific soil type or select their specific soil type from a list of choices. The list of choices may, for example, be modified based on the received location, e.g., the received longitude and latitude. In this way, the view depicted in FIG. 4, in which the user has selected “no” in the “do you know your soil type?” field 406 provides assistance to a user who does not know their specific soil type, instead allowing them to provide a category and a moisture condition instead. Alternatively, the specific soil characteristics or category of characteristics may be automatically determined based on the received location, e.g., the received longitude and latitude, in an instance in which the user selects “no.” In addition, as discussed previously and as indicated by the “previous crop adjusted soil condition” field 420, the soil profile moisture condition may be adjusted based on the previous crop. For example, as depicted in FIG. 4, the “previous crop adjusted soil condition” field 420 has been populated with “Low/33” based on the user's selection of “cotton” as their previous crop and “moderate/50%” as their soil moisture condition. Product recommendations may thus be determined based on the previous crop adjusted soil condition.

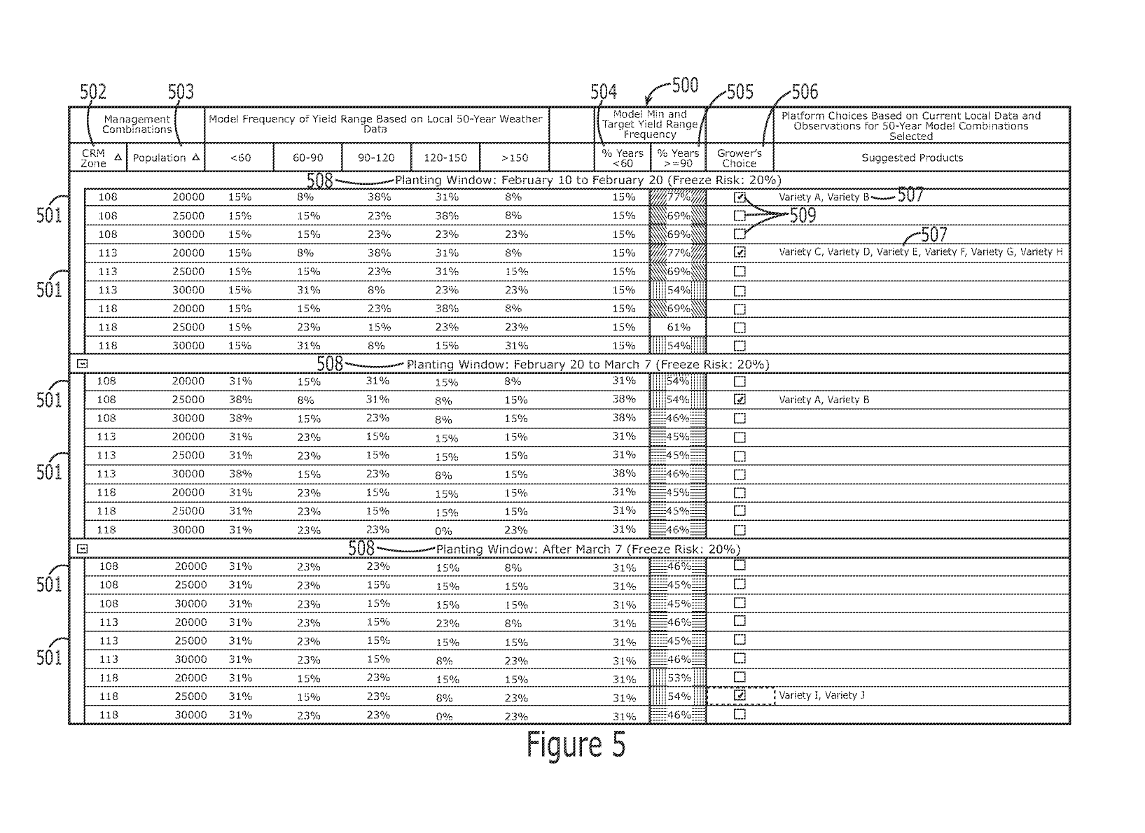

FIG. 5 depicts a “usage scenario selection” viewable area 500. The “usage scenario selection” viewable area 500 may include a plurality of usage scenarios 501. The usage scenarios may be presented along with their respective additional indications of the localized usage context, such as their respective comparative relative maturity 502, population 503, and planting window 508. As depicted, the usage scenarios 501 may be presented in a horizontal arrangement, e.g., as rows in a chart, and one or more of the indications of the localized usage scenarios may be presented in a vertical arrangement, e.g., as columns in a chart. As depicted, the planting windows 508 may also be presented depicted in a horizontal arrangement, e.g., subdividing the various usage scenarios 501 into one or more planting window categories (here, “February 10 to February 20,” “February 20 to March 7,” and “After March 7”) for ease of viewing and comprehension. As shown, the probability of not achieving the minimum yield 504 and the probability of achieving the target yield 505 may also be presented for each usage scenario 501. One or more of the probabilities may be color-coded, or otherwise presented in a way that allows a user to easily determine a magnitude of the probability at a glance. One or more selectable elements 509 may be presented, e.g., in a “grower's choice” column 506 as depicted here, to receive selection of one or more of the usage scenarios. As the usage scenarios are selected, one or more agricultural input recommendations 507 may be presented. The input recommendations 507 may, for example, be determined in response to receiving selection of the one or more usage scenarios, or may have been previously determined for each usage scenario and presented in response to the selection(s).

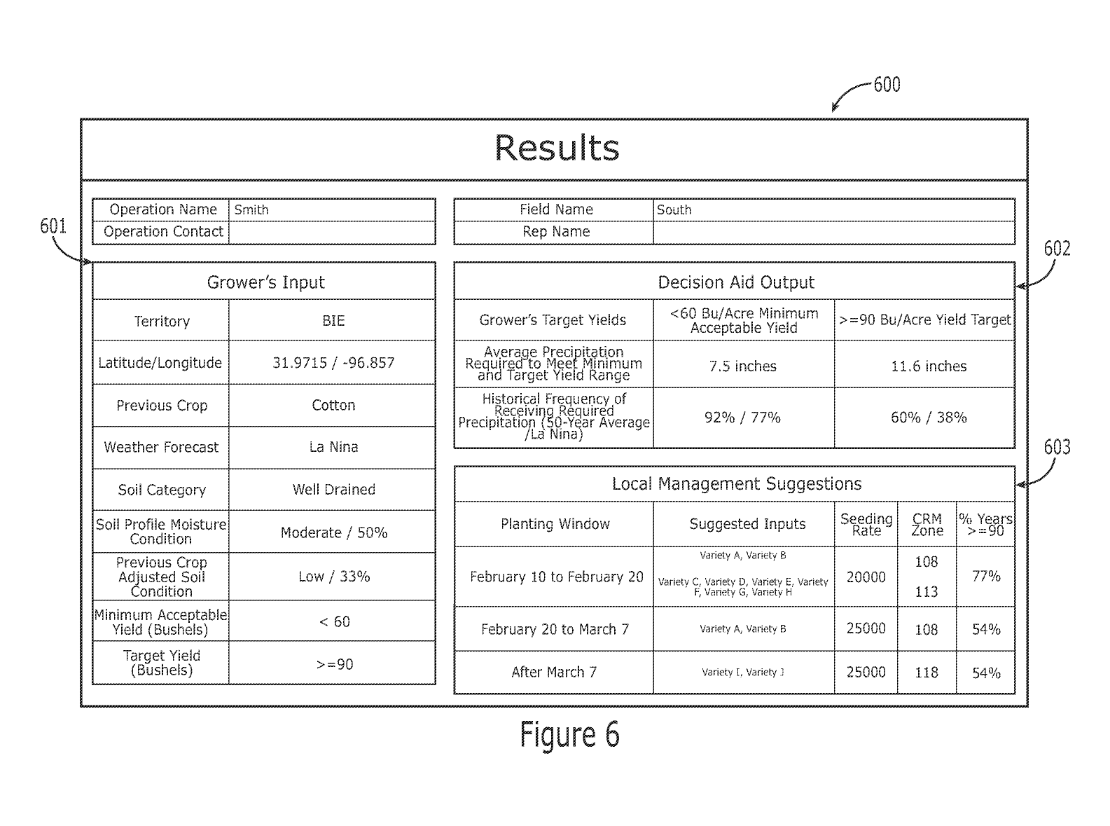

FIG. 6 depicts a “results” viewable area 600. The “results” viewable area is a summary of the indications of the localized usage context and the product recommendations. Thus, the “results” viewable area may include the initial indications of the localized usage context 601 along with the selected usage scenarios and their associated product recommendations 603. The “results” viewable area 600 may further include a “decision aid output” element 602, which may summarize one or more environmental conditions, such as an average precipitation, required to meet the target and minimum acceptable yields, along with the historical frequency of the environmental condition. The “results” viewable area 600 may also include agricultural input recommendations for multiple fields or portion of one or more fields (not depicted). As discussed above, these recommendations may include, for example, one or more plant varieties, planting dates or windows, planting depth, populations (planting densities), field preparation instructions, irrigation recommendations, nutrient, herbicide, fungicide and pesticide recommendations, seed treatment needs, field scouting guidelines, harvest instructions, and/or timing suggestions for accomplishing these recommendations. Additional recommendations may also be provided, such as financial and risk management tool recommendations, such as the use of crop insurance instruments or marketing services.

As described above, FIG. 3 illustrates a flowchart of an apparatus 200, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 208 of an apparatus 200 employing an embodiment of the present invention and executed by a processor 202 of the apparatus 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or enhanced. Furthermore, in some embodiments, additional optional operations may be included. Modifications, additions, or enhancements to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed:

1. A method for generating agricultural input recommendations, the method comprising:
receiving one or more indications of a localized usage context;
determining, based on the one or more indications, one or more suggested agricultural inputs; and
causing the one or more suggested agricultural inputs to be provided.

2. The method of claim 1, wherein the one or more indications of a localized usage context comprise at least one indication of a minimum acceptable yield and at least one indication of a target yield.

3. The method of claim 2, wherein the one or more indications of a localized usage context further comprise a geographic location, information regarding one or more environmental conditions, at least one soil characteristic, or at least one previous crop.

4. The method of claim 3, further comprising:
determining a probability of achieving the target yield based at least on the one or more indications of the localized usage context;
determining a probability of not achieving the minimum acceptable yield based at least on the one or more indications of the localized usage context; and
causing the probabilities to be displayed.

5. The method of claim 4, wherein the one or more indications of the localized usage context are initial indications of the localized usage context, the method further comprising:
causing a plurality of usage scenarios to be displayed, each of the usage scenarios being respectively associated with at least one additional indication of the localized usage context; and
receiving selection of one or more of the plurality of usage scenarios;
wherein determining one or more suggested agricultural inputs comprises respectively determining one or more suggested agricultural inputs for each of the selected usage scenarios based on the initial indications of the localized usage context and the additional indications of the localized usage context respectively associated with each of the selected usage scenarios.

6. The method of claim 5, wherein causing the one or more suggested agricultural inputs to be provided comprises causing at least one suggested agricultural input to be displayed for each selected usage scenario.

7. The method of claim 5, wherein the additional indications of the localized usage context comprise at least one indication of a population, at least one indication of a comparative relative maturity, or at least one indication of a planting window.

8. The method of claim 5, wherein respective probabilities of achieving the target yield and respective probabilities of not achieving the minimum acceptable yield are determined for each of the plurality of usage scenarios, the respective probabilities being determined based on the initial indications of the localized usage scenario and the at least one additional indication of the localized usage scenario respectively associated with each of the plurality of scenarios; and
further wherein causing the probabilities to be displayed comprises causing each of the probabilities to be respectively displayed along with each of the usage scenarios.

9. The method of claim 5, wherein the plurality of usage scenarios are caused to be displayed in a first viewable area and further wherein causing the one or more suggested agricultural inputs to be displayed comprises causing the one or more suggested agricultural inputs to be displayed in the first viewable area in response to receiving selection of the one or more usage scenarios, the method further comprising causing the one or more suggested agricultural inputs to be displayed in a second viewable area along with the initial and additional indicators of the localized usage scenario.

10. The method of claim 5, wherein the probability of achieving the target yield and not achieving the minimum acceptable yield are further determined by referencing a data model or dataset.

11. The method of claim 10, wherein the data model or dataset includes historical weather data.

12. The method of claim 3, wherein the at least one indication of a soil characteristic comprises an indication of a soil or subsoil moisture condition.

13. The method of claim 12, further comprising adjusting the received indication of the soil or subsoil moisture condition based on the received at least one indication of the previous crop.

14. The method of claim 3, wherein the at least one indication of a soil characteristic comprises an indication of a soil type.

15. The method of claim 3, wherein the at least one indication of a geographic location comprises an indication of a longitude and an indication of a latitude.

16. The method of claim 3, wherein determining the one or more agricultural input recommendations based on the one or more indications comprises determining one or more agricultural product recommendations based at least in part on an availability of one or more agricultural products in the geographic location.

17. The method of claim 3, wherein receiving the at least one indication of a geographic location comprises receiving the at least one indication of a geographic location via a graphical geographic representation.

18. The method of claim 1, wherein the one or more agricultural inputs comprise seed products.

19. The method of claim 18, wherein the one or more seed products comprise drought tolerant seed products.

20. The method of claim 1, wherein determining the recommended agricultural inputs comprises determining, before a planting associated with the localized usage context, agricultural inputs to be used during the planting.

21. The method of claim 20, wherein the recommended agricultural inputs comprise a crop type, a seed product, a planting density, a chemical treatment, a fertilizer, or a management practice.

22. The method of claim 1, wherein determining the recommended agricultural inputs comprises determining, during a growing season associated with the localized usage context, agricultural inputs to be used or adjusted during the growing season.

23. The method of claim 1, wherein determining the recommended agricultural inputs comprises determining, before a harvest associated with the localized usage context, agricultural inputs to be used subsequent to the harvest.

24. The method of claim 1, wherein determining the recommended agricultural inputs comprises determining, after a harvest associated with the localized usage context, agricultural inputs to be used subsequent to the harvest.

25. The method of claim 1, wherein causing the one or more suggested agricultural inputs to be provided comprises causing information regarding the one or more suggested agricultural inputs to be provided to one or more devices configured to apply or change the suggested agricultural inputs.

26. A method of producing a crop in a particular area comprising:
providing one or more indications of a localized usage context associated with the particular area to an agricultural recommendation system, the agricultural recommendation system being configured to:
receive the one or more indications of the localized usage context,
determine one or more suggested agricultural inputs based on the one or more indications, and
cause the one or more suggested agricultural inputs to be provided; and
producing the crop in the particular area in accordance with the one or more suggested agricultural inputs.

27. A method of managing an intra- or inter-field management zone comprising:
providing one or more indications of a localized usage context associated with the intra- or inter-field management zone to an agricultural recommendation system, the agricultural recommendation system being configured to:
receive the one or more indications of the localized usage context,
determine one or more suggested agricultural inputs based on the one or more indications, and
cause the one or more suggested agricultural inputs to be provided; and
managing the intra- or inter-field management zone in accordance with the one or more suggested agricultural inputs.

28. A method of optimizing a crop production comprising:
providing one or more indications of a localized usage context associated with the crop production to an agricultural recommendation system, the agricultural recommendation system being configured to:
receive the one or more indications of the localized usage context,
determine one or more optimized suggested agricultural inputs based on the one or more indications, and
cause the one or more optimized suggested agricultural inputs to be provided; and
producing the crop in accordance with the one or more optimized suggested agricultural inputs.

29. A method of minimizing crop production risk comprising:
providing one or more indications of a localized usage context associated with the crop production to an agricultural recommendation system, the agricultural recommendation system being configured to:
receive the one or more indications of the localized usage context,
determine one or more optimized suggested agricultural inputs based on the one or more indications, and
cause the one or more suggested agricultural inputs to be provided; and
producing the crop in accordance with the one or more suggested agricultural inputs;
wherein the indications of the localized usage context comprise information related to one or more risk levels.

30. A method of minimizing crop production input costs comprising:
providing one or more indications of a localized usage context associated with the crop production to an agricultural recommendation system, the agricultural recommendation system being configured to:
receive the one or more indications of the localized usage context,
determine one or more optimized suggested agricultural inputs based on the one or more indications, and
cause the one or more suggested agricultural inputs to be provided; and
producing the crop in accordance with the one or more suggested agricultural inputs;
wherein the indications of the localized usage context comprise information related to one or more input costs.

31. A computer program product for generating agricultural input recommendations, the computer program product comprising a non-transitory computer readable medium having program code portions embodied therein, the program code portions being configured to, upon execution, direct an apparatus to at least:
receive one or more indications of a localized usage context;
determine, based on the one or more indications, one or more suggested agricultural input; and
cause the one or more suggested agricultural inputs to be provided.

32. The computer program product of claim 31, wherein the one or more indications of a localized usage context comprise at least one indication of a minimum acceptable yield and at least one indication of a target yield.

33. The computer program product of claim 32, wherein the one or more indications of a localized usage context further comprise a geographic location, information regarding one or more environmental conditions, at least one soil characteristic, or at least one previous crop.

34. The computer program product of claim 33, wherein the program code portions are further configured to, upon execution, direct the apparatus to:
determine a probability of achieving the target yield based at least on the one or more indications of the localized usage context;
determine a probability of not achieving the minimum acceptable yield based at least on the one or more indications of the localized usage context; and
cause the probabilities to be displayed.

35. The computer program product of claim 34, wherein the one or more indications of the localized usage context are initial indications of the localized usage context, the program code portions being further configured to, upon execution, direct the apparatus to:
cause a plurality of usage scenarios to be displayed, each of the usage scenarios being respectively associated with at least one additional indication of the localized usage context; and
receive selection of one or more of the plurality of usage scenarios;
wherein the apparatus is directed to determine one or more suggested agricultural inputs by respectively determining one or more suggested agricultural inputs for each of the selected usage scenarios based on the initial indications of the localized usage context and the additional indications of the localized usage context respectively associated with each of the selected usage scenarios.

36. The computer program product of claim 35, wherein the apparatus is directed to cause the one or more suggested agricultural inputs to be provided by causing at least one suggested agricultural input to be displayed for each selected usage scenario.

37. The computer program product of claim 35, wherein the additional indications of the localized usage context comprise at least one indication of a population, at least one indication of a comparative relative maturity, or at least one indication of a planting window.

38. The computer program product of claim 35, wherein the apparatus is directed to determine respective probabilities of achieving the target yield and respective probabilities of not achieving the minimum acceptable yield for each of the plurality of usage scenarios, the respective probabilities being determined based on the initial indications of the localized usage scenario and the at least one additional indication of the localized usage scenario respectively associated with each of the plurality of scenarios; and
further wherein the apparatus is directed to cause the probabilities to be displayed by causing each of the probabilities to be respectively displayed along with each of the usage scenarios.

39. The computer program product of claim 35, wherein the apparatus is directed to cause the plurality of usage scenarios to be displayed in a first viewable area and to cause the one or more suggested agricultural inputs to be displayed in the first viewable area in response to receiving selection of the one or more usage scenarios, the apparatus being further directed to cause the one or more suggested agricultural inputs to be displayed in a second viewable area along with the initial and additional indicators of the localized usage scenario.

40. The computer program product of claim 35, wherein the probability of achieving the target yield and not achieving the minimum acceptable yield are further determined by referencing a data model or dataset.

41. The computer program product of claim 35, wherein the data model or dataset includes historical weather data.

42. The computer program product of claim 33, wherein the at least one indication of a soil characteristic comprises an indication of a soil or subsoil moisture condition.

43. The computer program product of claim 42, wherein the apparatus is further directed to adjust the received indication of the soil or subsoil moisture condition based on the received at least one indication of the previous crop.

44. The computer program product of claim 33, wherein the at least one indication of a soil characteristic comprises an indication of a soil type.

45. The computer program product of claim 33, wherein the at least one indication of a geographic location comprises an indication of a longitude and an indication of a latitude.

46. The computer program product of claim 33, wherein the apparatus is directed to determine the one or more agricultural input recommendations based on the one or more indications by determining one or more agricultural product recommendations based at least in part on an availability of one or more agricultural products in the geographic location.

47. The computer program product of claim 33, wherein the apparatus is directed to receive the at least one indication of a geographic location by receiving the at least one indication of a geographic location via a graphical geographic representation.

48. The computer program product of claim 31, wherein the one or more agricultural inputs comprise seed products.

49. The computer program product of claim 31, wherein the apparatus is directed to cause the one or more suggested agricultural inputs to be provided by causing information regarding the one or more suggest agricultural inputs to be provided to one or more devices configured to apply or change the suggested agricultural inputs.

50. An apparatus for generating agricultural input recommendations, the apparatus comprising at least one processor and at least one memory storing program code instructions, the at least one memory and program code instructions being configured to, with the at least one processor, direct an apparatus to at least:
receive one or more indications of a localized usage context;
determine, based on the one or more indications, one or more suggested agricultural inputs; and
cause the one or more suggested agricultural inputs to be provided.

51. The apparatus of claim 50, wherein the one or more indications of a localized usage context comprise at least one indication of a minimum acceptable yield and at least one indication of a target yield.

52. The apparatus of claim 51, wherein the one or more indications of a localized usage context further comprise a geographic location, information regarding one or more environmental conditions, at least one soil characteristic, or at least one previous crop.

53. The apparatus of claim 52, wherein the apparatus is further directed to:
determine a probability of achieving the target yield based at least on the one or more indications of the localized usage context;
determine a probability of not achieving the minimum acceptable yield based at least on the one or more indications of the localized usage context; and
cause the probabilities to be displayed.

54. The apparatus of claim 53, wherein the one or more indications of the localized usage context are initial indications of the localized usage context, the apparatus being further directed to:
cause a plurality of usage scenarios to be displayed, each of the usage scenarios being respectively associated with at least one additional indication of the localized usage context; and
receive selection of one or more of the plurality of usage scenarios;
wherein the apparatus is directed to determine one or more suggested agricultural inputs by respectively determining one or more suggested agricultural inputs for each of the selected usage scenarios based on the initial indications of the localized usage context and the additional indications of the localized usage context respectively associated with each of the selected usage scenarios.

55. The apparatus of claim 54, wherein the apparatus is directed to cause the one or more suggested agricultural inputs to be provided by causing at least one suggested agricultural input to be displayed for each selected usage scenario.

56. The apparatus of claim 54, wherein the additional indications of the localized usage context comprise at least one indication of a population, at least one indication of a comparative relative maturity, or at least one indication of a planting window.

57. The apparatus of claim 54, wherein the apparatus is directed to determine respective probabilities of achieving the target yield and respective probabilities of not achieving the minimum acceptable yield for each of the plurality of usage scenarios, the respective probabilities being determined based on the initial indications of the localized usage scenario and the at least one additional indication of the localized usage scenario respectively associated with each of the plurality of scenarios; and
further wherein the apparatus is directed to cause the probabilities to be displayed by causing each of the probabilities to be respectively displayed along with each of the usage scenarios.

58. The apparatus of claim 54, wherein the apparatus is directed to cause the plurality of usage scenarios to be displayed in a first viewable area and to cause the one or more suggested agricultural inputs to be displayed in the first viewable area in response to receiving selection of the one or more usage scenarios, the apparatus being further directed to cause the one or more suggested agricultural inputs to be displayed in a second viewable area along with the initial and additional indicators of the localized usage scenario.

59. The apparatus of claim 54, wherein the probability of achieving the target yield and not achieving the minimum acceptable yield are further determined by referencing a data model or dataset.

60. The apparatus of claim 59, wherein the data model or dataset includes historical weather data.

61. The apparatus of claim 52, wherein the at least one indication of a soil characteristic comprises an indication of a soil or subsoil moisture condition.

62. The apparatus of claim 61, wherein the apparatus is further directed to adjust the received indication of the soil or subsoil moisture condition based on the received at least one indication of the previous crop.

63. The apparatus of claim 52, wherein the at least one indication of a soil characteristic comprises an indication of a soil type.

64. The apparatus of claim 52, wherein the at least one indication of a geographic location comprises an indication of a longitude and an indication of a latitude.

65. The apparatus of claim 52, wherein the apparatus is directed to determine the one or more agricultural input recommendations based on the one or more indications by determining one or more agricultural product recommendations based at least in part on an availability of one or more agricultural products in the geographic location.

66. The apparatus of claim 52, wherein receiving the at least one indication of a geographic location comprises receiving the at least one indication of a geographic location via a graphical geographic representation.

67. The apparatus of claim 50, wherein the one or more agricultural inputs comprise seed products.

68. The apparatus of claim 50, wherein the apparatus is directed to cause the one or more suggested agricultural inputs to be provided by causing information regarding the one or more suggest agricultural inputs to be provided to one or more devices configured to apply or change the suggested agricultural inputs.
